(19) United States
(12) Patent Application Publication
(10) Pub. No.: US 2026/0100879 A1
(43) Pub. Date: Apr. 9, 2026

(54) TRACKABLE NODE PROVISIONING FOR MULTI-CLOUD ON LINK-LOCAL NETWORK

(71) Applicant: Dell Products L.P., Round Rock, TX (US)

(72) Inventors: Steven Jie CHEN, Shanghai (CN); Ken Kai ZHOU, Shanghai (CN)

(73) Assignee: Dell Products L.P., Round Rock, TX (US)

(21) Appl. No.: 18/917,135

(22) Filed: Oct. 16, 2024

(30) Foreign Application Priority Data
Sep. 19, 2024 (CN) 202411306238.7

(51) Int. Cl. H04L 41/0806; H04L 61/4541; H04L 61/5069; H04L 101/659

(52) U.S. Cl. CPC H04L 41/0806; H04L 61/4541; H04L 61/5069; H04L 2101/659

(57) ABSTRACT

An information handling system may include at least one processor and a memory. The information handling system may be configured to provide tracking for a provisioning process executing on a plurality of target nodes by: advertising a uniform resource locator (URL) of an endpoint via multicast domain name system (mDNS) and DNS Service Discovery (DNS SD) protocols on a computer network; receiving telemetry information from the plurality of target nodes during the provisioning process via the endpoint, wherein the telemetry information is received via link-local addresses of the plurality of target nodes; and providing a user with access to the telemetry information.

### TECHNICAL FIELD

The present disclosure relates in general to information handling systems, and more particularly to monitoring the process of provisioning new nodes in a cluster of information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCl) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCl solution is the Dell EMC VxRail™ system. Some examples of HCl systems may operate in various environments (e.g., an HCl management system such as the VMware® vSphere® ESXi™ environment, or any other HCl management system). Some examples of HCl systems may operate as software-defined storage (SDS) cluster systems (e.g., an SDS cluster system such as the VMware® vSAN™ system, or any other SDS cluster system).

In the HCl context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

When the nodes of a new cluster such as an HCl cluster are being deployed, various actions are typically taken to prepare them for use, including imaging the nodes and provisioning them with the correct software and firmware components. These actions may take a significant amount of time and involve fairly complex processes. Thus it is desirable to be able to track the progress of such actions in real time, including the state of each node, the installation progress of the different components being installed, etc. from a centralized location.

However, in some cases, the nodes may be in a deployment that does not yet have the infrastructure in place to allow such tracking to be carried out easily. For example, the target nodes (those being monitored) may not yet have internet access. Indeed, they may not even have an Internet Protocol (IP) address yet at the provisioning stage, and there may not be any Dynamic Host Configuration Protocol (DHCP) or Domain Name System (DNS) server available to facilitate network communication.

Embodiments of this disclosure allow monitoring of the node provisioning process even in deployments that lack such infrastructure, as long as the nodes are on the same link-local network (e.g., on the same subnet).

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with monitoring the deployment of nodes of an information handling system cluster may be reduced or eliminated.

In accordance with embodiments of the present disclosure, an information handling system may include at least one processor and a memory. The information handling system may be configured to provide tracking for a provisioning process executing on a plurality of target nodes by: advertising a uniform resource locator (URL) of an endpoint via multicast domain name system (mDNS) and DNS Service Discovery (DNS SD) protocols on a computer network; receiving telemetry information from the plurality of target nodes during the provisioning process via the endpoint, wherein the telemetry information is received via link-local addresses of the plurality of target nodes; and providing a user with access to the telemetry information.

In accordance with these and other embodiments of the present disclosure, a method for providing tracking for a provisioning process executing on a plurality of target nodes may include: an information handling system advertising a uniform resource locator (URL) of an endpoint via multicast domain name system (mDNS) and DNS Service Discovery (DNS SD) protocols on a computer network; the information handling system receiving telemetry information from the plurality of target nodes during the provisioning process via the endpoint, wherein the telemetry information is received via link-local addresses of the plurality of target nodes; and the information handling system providing a user with access to the telemetry information.

In accordance with these and other embodiments of the present disclosure, an article of manufacture may include a non-transitory, computer-readable medium having computer-executable instructions thereon that are executable by a processor of an information handling system for: providing tracking for a provisioning process executing on a plurality of target nodes by: advertising a uniform resource locator (URL) of an endpoint via multicast domain name system (mDNS) and DNS Service Discovery (DNS SD) protocols on a computer network; receiving telemetry information from the plurality of target nodes during the provisioning process via the endpoint, wherein the telemetry information is received via link-local addresses of the plurality of target nodes; and providing a user with access to the telemetry information.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a system architecture diagram, in accordance with embodiments of the present disclosure; and

FIG. 3 illustrate an example method, in accordance with embodiments of the present disclosure.

### DETAILED DESCRIPTION

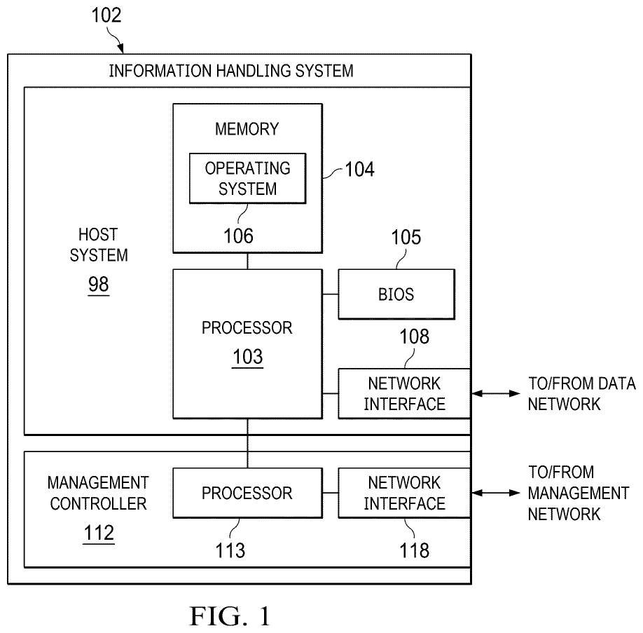

Preferred embodiments and their advantages are best understood by reference to FIGS. 1 through 3, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades. ” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC. ” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, information handling system 102 may be a node of a cluster of information handling systems. During cluster deployment, several node information handling systems 102 may be connected to a network hub or switch and powered on, such that they can communicate with one another, but may not be able to communicate with other information handling systems.

Embodiments of this disclosure allow one node to act as a monitor node, while the others act as target nodes. The monitor node may be used to collect telemetry regarding the target nodes (as well as itself, in its capacity as a target node being provisioned) during the provisioning process, providing real-time tracking of that process to an administrator.

In one embodiment, a monitor node may execute a web server referred to herein as “trace-server”. This component may provide a set of one or more REST APIs, which may be accessed by the target nodes to allow them to report information to the monitor node. The monitor node may also execute a multicast DNS (mDNS) server referred to herein as “trace-mdns”. This daemon may be used to advertise the endpoint URL(s) of the trace-server component based on the mDNS and the DNS Service Discovery (DNS-SD) protocols. The trace-mdns component may be configured to work with link-local addresses (e.g., IPv6 link-local addresses).

Each target node may execute a script referred to herein as “collect-info”. This script may be configured to collect all relevant information from the target node at each installation stage for storage in an “info.dat” file. Generally, the installation of an OS installation includes three stages: (1) while the OS installer is running, the installer may provide an API to allow the collect-info script to gather information about installation and startup of the new OS; (2) during operation of a kickstart or answer file, the collect-info script may retrieve and store customized configuration information from such files; and (3) during execution of any customized scripts, the collect-info script may retrieve execution information from such scripts.

Each target node may further execute an mDNS client daemon referred to herein as “trace-client”. The trace-client component may be configured to find the endpoint URL(s) for the trace-server component of the monitor node by sending a DNS-SD query during the first OS startup. The trace-client component may then receive notifications. For example, whenever the info. dat file is updated, the collect-info script may send a notification to trace-client. The trace-client daemon may also call out to a trace-server endpoint URL to report any notifications to the monitor node.

These various components of the monitor node and the target nodes may be implemented via containers, VMs, bare metal programs, or any other suitable paradigm.

In some embodiments, a single monitor node may be used to monitor multiple groups of target nodes. For example, the groups may be individual clusters being deployed for different use cases (e.g., systems being deployed in a single datacenter for different cloud intents, different models of servers being deployed for different purposes, etc.).

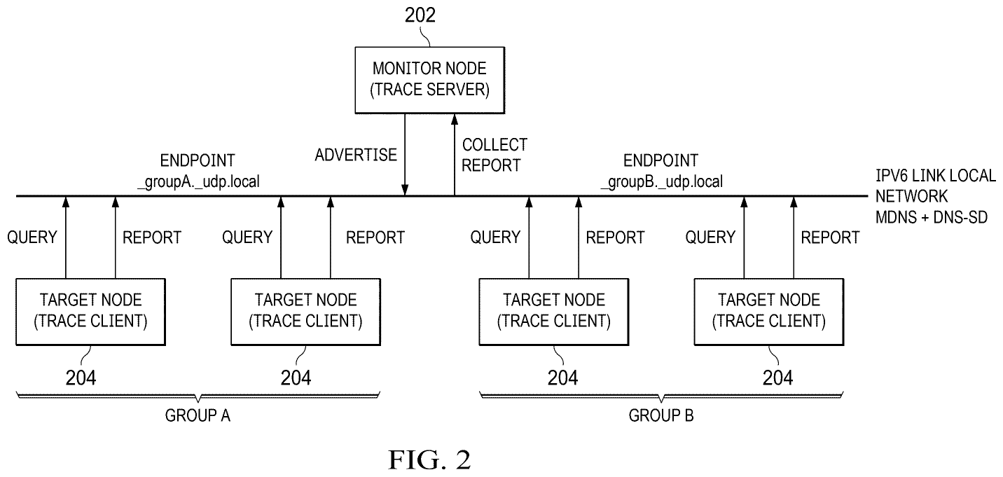

FIG. 2 shows an example deployment including one monitor node 202 and several target nodes 204. Group A includes two target nodes 204 that may be accessed via _groupA._udp.local, and Group B includes two target nodes 204 that may be accessed via_groupB._udp.local.

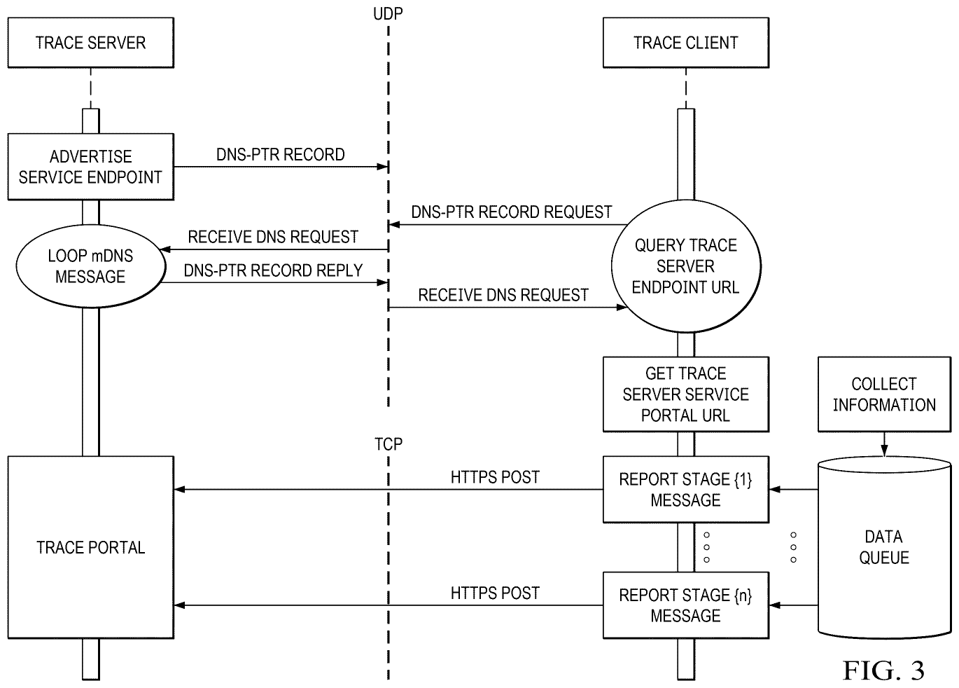

FIG. 3 shows an example sequence diagram method, in accordance with some embodiments.

Initially, the monitor node's trace-server and the target node's trace-client may communicate via UDP. As shown, the trace-server may advertise its service endpoint, and the trace-client may determine the correct endpoint URL.

The trace-server and trace-client may then begin communicating via TCP. The trace-client may collect information as discussed above, placing the information into a data queue. It may then transmit the items from the data queue to the trace-server, for example via HTTPS POST messages.

One of ordinary skill in the art with the benefit of this disclosure will understand that the preferred initialization point for the method depicted in FIG. 3 and the order of the steps comprising that method may depend on the implementation chosen. In these and other embodiments, these method may be implemented as hardware, firmware, software, applications, functions, libraries, or other instructions. Further, although FIG. 3 discloses a particular number of steps to be taken with respect to the disclosed method, the method may be executed with greater or fewer steps than depicted. The method may be implemented using any of the various components disclosed herein (such as the components of FIG. 1), and/or any other system operable to implement the method.

Thus embodiments of this disclosure may provide many advantages. Embodiments may have minimal network requirements (e.g., only the existence of an IP link-local network, with no reliance on other network services. The implementation of a common trace-client solution may be leveraged across many different product lines. Embodiments may be used to extend existing products with zero-configuration features, providing centralized management for many different product lines based on their group definitions.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S. C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]”construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to provide tracking for a provisioning process executing on a plurality of target nodes by:
advertising a uniform resource locator (URL) of an endpoint via multicast domain name system (mDNS) and DNS Service Discovery (DNS-SD) protocols on a computer network;
receiving telemetry information from the plurality of target nodes during the provisioning process via the endpoint, wherein the telemetry information is received via link-local addresses of the plurality of target nodes; and
providing a user with access to the telemetry information.

2. The information handling system of claim 1, wherein the information handling system is an element of a hyper-converged infrastructure (HCl) system.

3. The information handling system of claim 1, wherein the link-local addresses are IPv6 addresses.

4. The information handling system of claim 1, wherein the computer network does not include a non-multicast domain name system (DNS) server.

5. The information handling system of claim 1, wherein the computer network does not include a dynamic host configuration protocol (DHCP) server.

6. The information handling system of claim 1, wherein the plurality of target nodes includes a first group of target nodes of a first type, and a second group of target nodes of a second type.

7. A method for providing tracking for a provisioning process executing on a plurality of target nodes by:
an information handling system advertising a uniform resource locator (URL) of an endpoint via multicast domain name system (mDNS) and DNS Service Discovery (DNS SD) protocols on a computer network;
the information handling system receiving telemetry information from the plurality of target nodes during the provisioning process via the endpoint, wherein the telemetry information is received via link-local addresses of the plurality of target nodes; and
the information handling system providing a user with access to the telemetry information.

8. The method of claim 7, wherein the information handling system is an element of a hyper-converged infrastructure (HCl) system.

9. The method of claim 7, wherein the link-local addresses are IPv6 addresses.

10. The method of claim 7, wherein the computer network does not include a non-multicast domain name system (DNS) server.

11. The method of claim 7, wherein the computer network does not include a dynamic host configuration protocol (DHCP) server.

12. The method of claim 7, wherein the plurality of target nodes includes a first group of target nodes of a first type, and a second group of target nodes of a second type.

13. An article of manufacture comprising a non-transitory, computer-readable medium having computer-executable instructions thereon that are executable by a processor of an information handling system for:
providing tracking for a provisioning process executing on a plurality of target nodes by:
advertising a uniform resource locator (URL) of an endpoint via multicast domain name system (mDNS) and DNS Service Discovery (DNS SD) protocols on a computer network;
receiving telemetry information from the plurality of target nodes during the provisioning process via the endpoint, wherein the telemetry information is received via link-local addresses of the plurality of target nodes; and
providing a user with access to the telemetry information.

14. The article of claim 13, wherein the information handling system is an element of a hyper-converged infrastructure (HCl) system.

15. The article of claim 13, wherein the link-local addresses are IPv6 addresses.

16. The article of claim 13, wherein the computer network does not include a non-multicast domain name system (DNS) server.

17. The article of claim 13, wherein the computer network does not include a dynamic host configuration protocol (DHCP) server.

18. The article of claim 13, wherein the plurality of target nodes includes a first group of target nodes of a first type, and a second group of target nodes of a second type.
